(19) United States
(12) Patent Application Publication
(10) Pub. No.: US 2016/0026689 A1
(43) Pub. Date: Jan. 28, 2016

(54) SYSTEM AND PROCESS TO FACILITATE COURSE REGISTRATION AND OPTIMAL CLASS SELECTION

(71) Applicant: COLLEGE SCHEDULER LLC, Redding, CA (US)

(72) Inventor: Robert STRAZZARINO, Redding, CA (US)

(21) Appl. No.: 14/874,984

(22) Filed: Oct. 5, 2015

Related U.S. Application Data
(63) Continuation of application No. 13/773,301, filed on Feb. 21, 2013, now abandoned.
(60) Provisional application No. 61/849,812, filed on Feb. 8, 2013.

(51) Int. Cl. G06F 17/30

(52) U.S. Cl. CPC G06F 17/30528; G06F 17/30554; G06F 17/30345; G06Q 50/2053

(57) ABSTRACT

The disclosure is directed to online registration systems for education institutions, particularly higher education institutions, provide a registration function for students to register for classes. Registration can be achieved by creating a single record for each individual course in a centrally accessible system; obtaining a selection of one or more courses from a user; generating a list of two or more course schedules without user interaction; and presenting the list of two or more course schedule to the user.

### CROSS-REFERENCE

This application is a continuation of U.S. patent application Ser. No. 13/773,301 filed Feb. 21, 2013, which claims the benefit of U.S. Provisional Application No. 61/849,812 filed Feb. 8, 2013, entitled System and Process to Facilitate Course Registration and Optimal Class Selection, all which are incorporated herein by reference.

### BACKGROUND OF THE INVENTION

Online registration systems for education institutions, particularly higher education institutions, provide a registration function for students to register for classes. Existing systems allow the university to publish class offerings through the registration system for students to pick from. These systems provide class search web pages in which students can search by subject and course to find class offerings for the upcoming terms they wish to register for. These systems are simple print outs of the various information about each class offering, such as the instructor, times at which the course is taught, seat availability information, campus, location, and various other fields. The class search pages are published and sections of the classes (individual offerings of each course) are presented in an ordered fashion, typically ordered by the section number.

One of the disadvantages of this approach is that sections are not shown in any particular order to the student and students have to pick through times manually, using pen and paper or some sort of spreadsheet software to piece together individual courses to assemble a potential schedule for the upcoming term. Typically, students will develop many trial schedules through a trial and error process, and this is a time consuming process for the student. The institution has no way of “advertising” particular sections over others and this can result in some sections not filling enough seats to be a profitable class offering. Other times, not filling enough seats in the sections can result in classes being cancelled.

Another disadvantage of the traditional course search is that universities do not have a feel for which students are searching for particular courses. Although existing degree planning software shows future course demand, when it comes time for students to actually look through the various sections on the course search, they are still planning with pen and paper or a worksheet which is offline and not accessible by the institution. As a result, institutions are not able to aggregate course demand data at the course level as well as drilled down to the individual student level. By not seeing course demand for the actual schedule planning process, institutions are missing vital data that can help them adjust class offerings right up to the registration opening up, instead of semesters in advance in which student plans can change. Even for institutions that use degree planning software, if students do not use the degree planning software then the data is not usable by the institution. However, every student must make a schedule each semester and this data is not captured by the institution. There is a much higher participation rate for students planning schedules as this is a required activity for taking classes, entering in future demand for courses is not a necessary step for a student to take classes and graduate.

Student Information Systems provide no reporting engine capable of showing the number of possible schedules based on any definable scenario. What is needed is a system and process that allows institutions to define scenarios in order to ensure that common student scheduling configurations are actually possible to register for and how many possibilities exist.

### SUMMARY OF THE INVENTION

Students are now able to enter in the courses they wish to take for the upcoming semester, and the automated student schedule planning software will produce fully pre-made schedules for the student to register for. Institutions can view the course demand entered by the students and make decisions to avoid inadequate course offerings based on student demand. The Enrollment Optimization Engine allows institutions to control which sections are presented to students first in the generated schedules. By assigning a weighted value to each section, universities can identify sections which are not filling up fast enough and prioritize the display of those sections to the students looking for schedules to register for.

Another problem solved is being able to ensure that common scheduling configurations (sets of desired courses with filters and breaks) actually are available for the student. Knowing how many possible schedule combinations exist for scheduling combinations can help the institution design and refine their class schedule offerings.

Traditional course search pages are only simple listings of the available courses in no particular order or weighted fashion. By using an automated schedule planner for the student and weighting courses with the Enrollment Optimization Engine, the advantage provided is that institutions can fill up particular sections faster than others and balance their enrollment across available sections. By being able to view course demand ‘just in-time” they can fine tune their scheduling offerings using data about what classes students are actually planning for, rather than just what they entered in their future degree plan.

An aspect of the disclosure is directed to a tangible machine readable medium storing instructions that, when executed by a computing device, cause the computing device to perform a method of compiling a course schedule. The method comprises: creating a single record for each individual course; obtaining a selection of one or more courses from a user; and listing two or more course schedules. Additionally, the performed method can further comprise one or more of each of, identifying one or more of each of available times for class, unavailable times for class, academic career, and course of study, and identifying for each course one or more of a favorite section, an undesirable section, and an instruction mode. In some configurations, one or more course records are equally weighted with one or more course records, while in other configurations, one or more course records is weighted. Weighted courses are displayed at available times prioritizable in order of weight. Two or more proposed course schedules are also viewable side by side. Additionally, a course schedule can be selected and forwarded to a central registration system.

Another aspect of the disclosure is directed to a method of enrolling one or more students in a course. The method comprises: creating a single record for each individual course in a centrally accessible system; obtaining a selection of one or more courses from a user; and listing two or more course schedules. Additionally, the method can further comprise one or more of each of identifying one or more of each of available times for class, unavailable times for class, academic career, and course of study, and identifying for each course one or more of a favorite section, an undesirable section, and an instruction mode. In some configurations, one or more course records are equally weighted with one or more course records, while in other configurations, one or more course records is weighted. Courses are displayable at available times in order of weight. Two or more course schedules are viewable side by side. Additionally, a course schedule can be selected and forwarded to a central registration system.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a block diagram showing a representative example of a logic device through which course registration can be achieved;

FIG. 1B is a block diagram of an exemplary computing environment through which course registration can be achieved;

FIG. 1C is an illustrative architectural diagram showing some structure that can be employed by devices through which course registration is achieved;

FIG. 2 is a block diagram showing the cooperation of exemplary components of a system suitable for use in a system where course registration is achieved;

FIG. 3 illustrates a course registration course demand data API flow;

FIGS. 4A-B illustrate a course optimization engine, both weighted and unweighted;

FIG. 5 illustrates a student schedule planner;

FIG. 6 illustrates course demand 600 which is capable of generating a course demand summary; and

FIGS. 7A-B illustrate a course optimization engine, weighted, priorities modified and auto threshold enabled.

### DETAILED DESCRIPTION OF THE INVENTION

### I. Computing Systems

The systems and methods described herein rely on a variety of computer systems, networks and/or digital devices for operation. In order to fully appreciate how the system operates an understanding of suitable computing systems is useful. The systems and methods disclosed herein are enabled as a result of application via a suitable computing system.

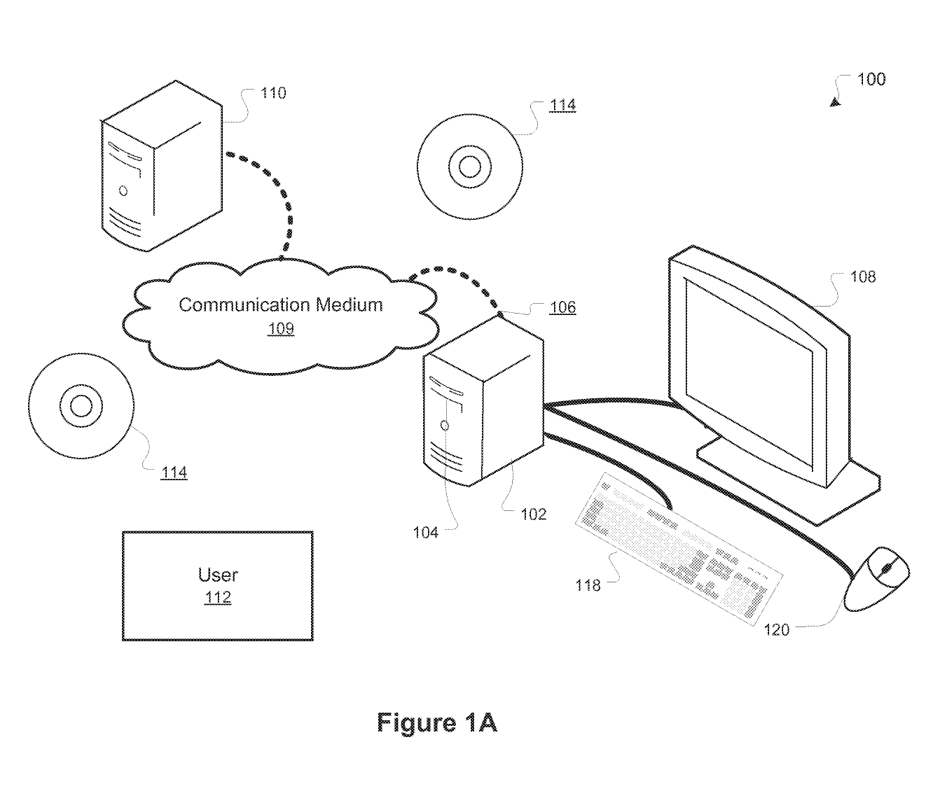

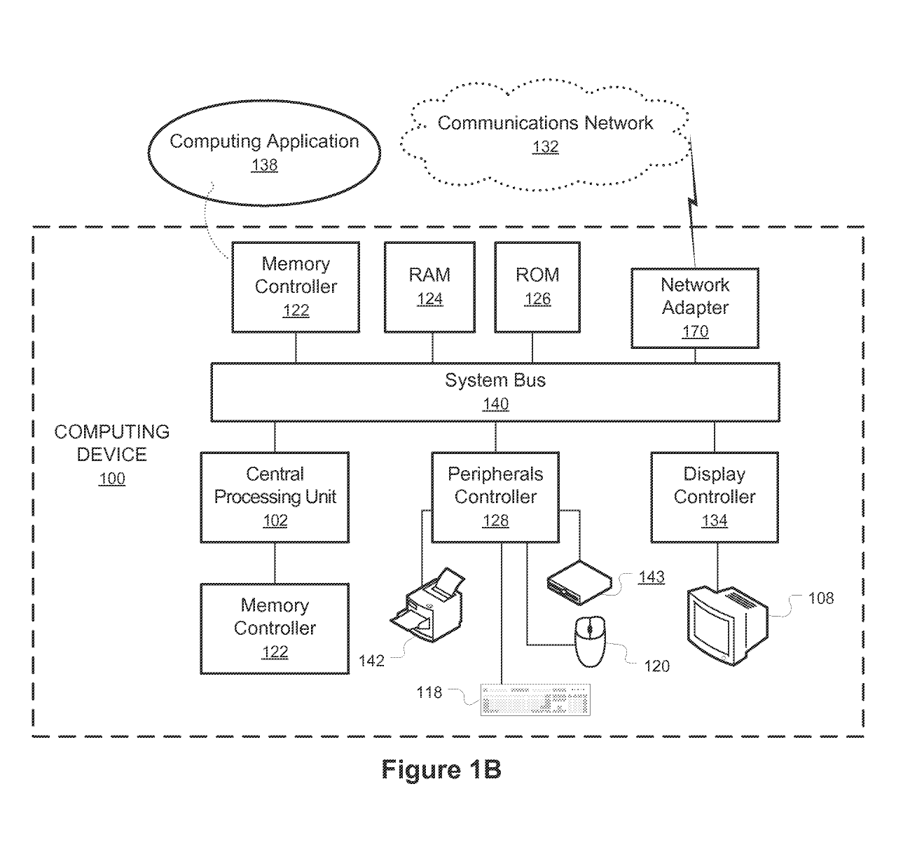

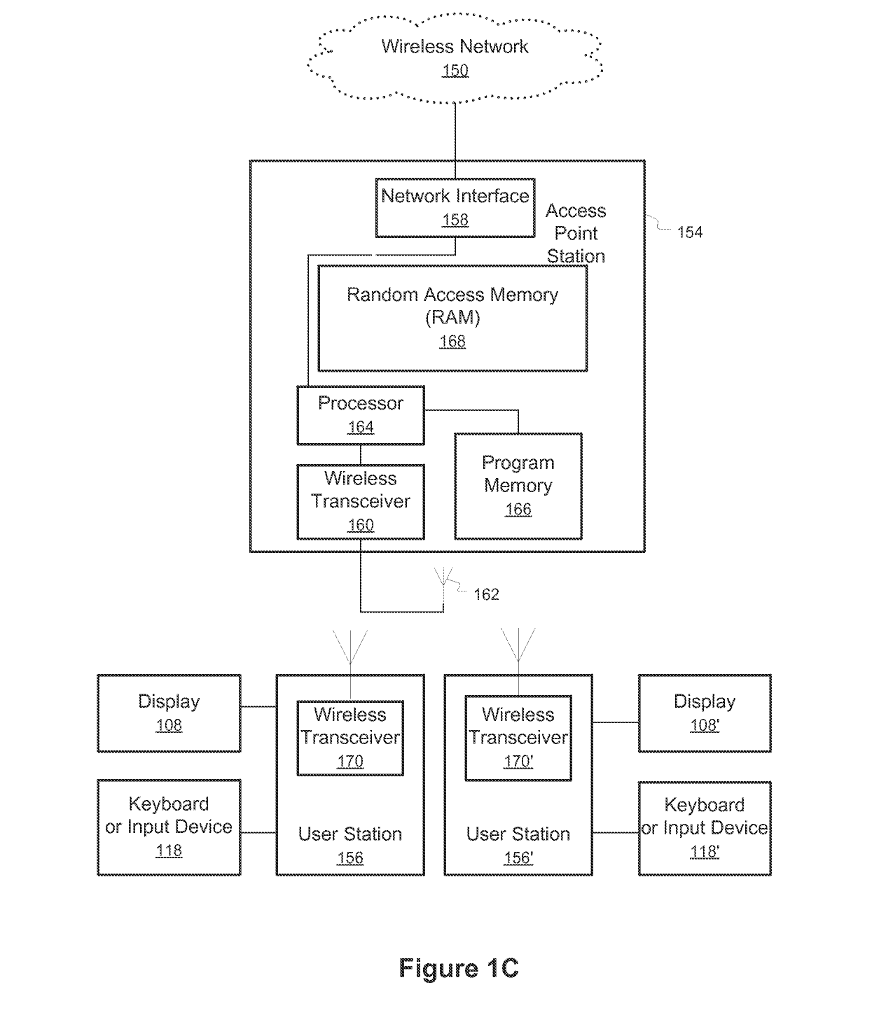

FIG. 1A is a block diagram showing a representative example logic device through which a browser can be accessed to implement the present invention. A computer system (or digital device) 100, which may be understood as a logic apparatus adapted and configured to read instructions from media 114 and/or network port 106, is connectable to a server 110, and has a fixed media 116. The computer system 100 can also be connected to the Internet or an intranet. The system includes central processing unit (CPU) 102, disk drives 104, optional input devices, illustrated as keyboard 118 and/or mouse 120 and optional monitor 108. Data communication can be achieved through, for example, communication medium 109 to a server 110 at a local or a remote location. The communication medium 109 can include any suitable means of transmitting and/or receiving data. For example, the communication medium can be a network connection, a wireless connection or an internet connection. It is envisioned that data relating to the present invention can be transmitted over such networks or connections. The computer system can be adapted to communicate with a participant and/or a device used by a participant. The computer system is adaptable to communicate with other computers over the Internet, or with computers via a server.

FIG. 1B depicts another exemplary computing system 100. The computing system 100 is capable of executing a variety of computing applications 138, including computing applications, a computing applet, a computing program, or other instructions for operating on computing system 100 to perform at least one function, operation, and/or procedure. Computing system 100 is controllable by computer readable storage media for tangibly storing computer readable instructions, which may be in the form of software. The computer readable storage media adapted to tangibly store computer readable instructions can contain instructions for computing system 100 for storing and accessing the computer readable storage media to read the instructions stored thereon themselves. Such software may be executed within CPU 102 to cause the computing system 100 to perform desired functions. In many known computer servers, workstations and personal computers CPU 102 is implemented by micro-electronic chips CPUs called microprocessors. Optionally, a co-processor, distinct from the main CPU 102, can be provided that performs additional functions or assists the CPU 102. The CPU 102 may be connected to co-processor through an interconnect. One common type of coprocessor is the floating-point coprocessor, also called a numeric or math coprocessor, which is designed to perform numeric calculations faster and better than the general-purpose CPU 102.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Some embodiments may be implemented in one or a combination of hardware, firmware and software. Embodiments may also be implemented as instructions stored on a non-transitory computer-readable storage medium, which may be read and executed by at least one processor to perform the operations described herein. A non-transitory computer-readable storage medium may include any mechanism for storing information in a form readable by a machine (e.g., a computer). For example, a non-transitory computer-readable storage medium may include read-only memory (ROM), random-access memory (RAM), magnetic disk storage media, optical storage media, flash-memory devices, and other non-transitory media.

In operation, the CPU 102 fetches, decodes, and executes instructions, and transfers information to and from other resources via the computer's main data-transfer path, system bus 140. Such a system bus connects the components in the computing system 100 and defines the medium for data exchange. Memory devices coupled to the system bus 140 include random access memory (RAM) 124 and read only memory (ROM) 126. Such memories include circuitry that allows information to be stored and retrieved. The ROMs 126 generally contain stored data that cannot be modified. Data stored in the RAM 124 can be read or changed by CPU 102 or other hardware devices. Access to the RAM 124 and/or ROM 126 may be controlled by memory controller 122. The memory controller 122 may provide an address translation function that translates virtual addresses into physical addresses as instructions are executed.

In addition, the computing system 100 can contain peripherals controller 128 responsible for communicating instructions from the CPU 102 to peripherals, such as, printer 142, keyboard 118, mouse 120, and data storage drive 143. Display 108, which is controlled by a display controller 163, is used to display visual output generated by the computing system 100. Such visual output may include text, graphics, animated graphics, and video. The display controller 134 includes electronic components required to generate a video signal that is sent to display 108. Further, the computing system 100 can contain network adaptor 136 which may be used to connect the computing system 100 to an external communications network 132.

### II. Networks and Internet Protocol

As is well understood by those skilled in the art, the Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

The Internet Protocol (IP) enables data to be sent from one device (e.g., a phone, a Personal Digital Assistant (PDA), a computer, etc.) to another device on a network. There are a variety of versions of IP today, including, e.g., IPv4, IPv6, etc. Other IPs are no doubt available and will continue to become available in the future, any of which can be used without departing from the scope of the invention. Each host device on the network has at least one IP address that is its own unique identifier and acts as a connectionless protocol. The connection between end points during a communication is not continuous. When a user sends or receives data or messages, the data or messages are divided into components known as packets. Every packet is treated as an independent unit of data and routed to its final destination—but not necessarily via the same path.

The Open System Interconnection (OSI) model was established to standardize transmission between points over the Internet or other networks. The OSI model separates the communications processes between two points in a network into seven stacked layers, with each layer adding its own set of functions. Each device handles a message so that there is a downward flow through each layer at a sending end point and an upward flow through the layers at a receiving end point. The programming and/or hardware that provides the seven layers of function is typically a combination of device operating systems, application software, TCP/IP and/or other transport and network protocols, and other software and hardware.

Typically, the top four layers are used when a message passes from or to a user and the bottom three layers are used when a message passes through a device (e.g., an IP host device). An IP host is any device on the network that is capable of transmitting and receiving IP packets, such as a server, a router or a workstation. Messages destined for some other host are not passed up to the upper layers but are forwarded to the other host. The layers of the OSI model are listed below. Layer 7 (i.e., the application layer) is a layer at which, e.g., communication partners are identified, quality of service is identified, user authentication and privacy are considered, constraints on data syntax are identified, etc. Layer 6 (i.e., the presentation layer) is a layer that, e.g., converts incoming and outgoing data from one presentation format to another, etc. Layer 5 (i.e., the session layer) is a layer that, e.g., sets up, coordinates, and terminates conversations, exchanges and dialogs between the applications, etc. Layer-4 (i.e., the transport layer) is a layer that, e.g., manages end-to-end control and error-checking, etc. Layer-3 (i.e., the network layer) is a layer that, e.g., handles routing and forwarding, etc. Layer-2 (i.e., the data-link layer) is a layer that, e.g., provides synchronization for the physical level, does bit-stuffing and furnishes transmission protocol knowledge and management, etc. The Institute of Electrical and Electronics Engineers (IEEE) sub-divides the data-link layer into two further sub-layers, the MAC (Media Access Control) layer that controls the data transfer to and from the physical layer and the LLC (Logical Link Control) layer that interfaces with the network layer and interprets commands and performs error recovery. Layer 1 (i.e., the physical layer) is a layer that, e.g., conveys the bit stream through the network at the physical level. The IEEE sub-divides the physical layer into the PLCP (Physical Layer Convergence Procedure) sub-layer and the PMD (Physical Medium Dependent) sub-layer.

### III. Wireless Networks

Wireless networks can incorporate a variety of types of mobile devices, such as, e.g., cellular and wireless telephones, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components: a transceiver (for example a transmitter and a receiver, including a single chip transceiver with an integrated transmitter, receiver and, if desired, other functions); an antenna; a processor; display; one or more audio transducers (for example, a speaker or a microphone as in devices for audio communications); electromagnetic data storage (such as ROM, RAM, digital data storage, etc., such as in devices where data processing is provided); memory; flash memory; and/or a full chip set or integrated circuit; interfaces (such as universal serial bus (USB), coder-decoder (CODEC), universal asynchronous receiver-transmitter (UART), phase-change memory (PCM), etc.). Other components can be provided without departing from the scope of the invention.

Wireless LANs (WLANs) in which a mobile user can connect to a local area network (LAN) through a wireless connection may be employed for wireless communications. Wireless communications can include communications that propagate via electromagnetic waves, such as light, infrared, radio, and microwave. There are a variety of WLAN standards that currently exist, such as Bluetooth®, IEEE 802.11, and the obsolete HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a personal computing memory card International Association (PCMCIA) card (or PC card) or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, WiMAX (Worldwide Interoperability for Microwave Access), Multiple Interface Devices (MIDs), 802.11x devices (IEEE 802.11 devices including, 802.11a, 802.11b and 802.11g devices), HomeRF (Home Radio Frequency) devices, Wi-Fi (Wireless Fidelity) devices, GPRS (General Packet Radio Service) devices, 3 G cellular devices, 2.5 G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds a mechanism to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using Internet Control Message Protocol (ICMP).

In basic IP routing (e.g., outside mobile IP), routing mechanisms rely on the assumptions that each network node always has a constant attachment point to the Internet and that each node's IP address identifies the network link it is attached to. In this document, the terminology “node” includes a connection point, which can include a redistribution point or an end point for data transmissions, and which can recognize, process and/or forward communications to other nodes. For example, Internet routers can look at an IP address prefix or the like identifying a device's network. Then, at a network level, routers can look at a set of bits identifying a particular subnet. Then, at a subnet level, routers can look at a set of bits identifying a particular device. With typical mobile IP communications, if a user disconnects a mobile device from the Internet and tries to reconnect it at a new subnet, then the device has to be reconfigured with a new IP address, a proper netmask and a default router. Otherwise, routing protocols would not be able to deliver the packets properly.

FIG. 1C depicts components that can be employed in system configurations enabling the systems and technical effect of this invention, including wireless access points to which client devices communicate. In this regard, FIG. 1C shows a wireless network 150 connected to a wireless local area network (WLAN) 152. The WLAN 152 includes an access point (AP) 154 and a number of user stations 156, 156′. For example, the network 150 can include the Internet or a corporate data processing network. The access point 154 can be a wireless router, and the user stations 156, 156′ can be portable computers, personal desk-top computers, PDAs, portable voice-over-IP telephones and/or other devices. The access point 154 has a network interface 158 linked to the network 150, and a wireless transceiver in communication with the user stations 156, 156′. For example, the wireless transceiver 160 can include an antenna 162 for radio or microwave frequency communication with the user stations 156, 156′. The access point 154 also has a processor 164, a program memory 166, and a random access memory 168. The user station 156 has a wireless transceiver 170 including an antenna 172 for communication with the access point station 154. In a similar fashion, the user station 156′ has a wireless transceiver 170′ and an antenna 172 for communication to the access point 154. By way of example, in some embodiments an authenticator could be employed within such an access point (AP) and/or a supplicant or peer could be employed within a mobile node or user station. Desktop 108 and key board 118 or input devices can also be provided with the user status.

### IV. Media Independent Handover Services

In IEEE P802.21/D.Ol.09, September 2006, entitled Draft IEEE Standard for Local and Metropolitan Area Networks: Media Independent Handover Services, among other things, the document specifies 802 media access-independent mechanisms that optimize handovers between 802 systems and cellular systems. The IEEE 802.21 standard defines extensible media access independent mechanisms that enable the optimization of handovers between heterogeneous 802 systems and may facilitate handovers between 802 systems and cellular systems. “The scope of the IEEE 802.21 (Media Independent Handover) standard is to develop a specification that provides link layer intelligence and other related network information to upper layers to optimize handovers between heterogeneous media. This includes links specified by 3GPP, 3GPP2 and both wired and wireless media in the IEEE 802 family of standards. Note, in this document, unless otherwise noted, “media” refers to method/mode of accessing a telecommunication system (e.g. cable, radio, satellite, etc.), as opposed to sensory aspects of communication (e.g. audio, video, etc.).” See 1.1 of I.E.E.E. P802.21/D.01.09, September 2006, entitled Draft IEEE Standard for Local and Metropolitan Area Networks: Media Independent Handover Services, the entire contents of which document is incorporated herein into and as part of this patent application. Other IEEE, or other such standards on protocols can be relied on as appropriate or desirable.

The computer implemented system provides a storage and delivery base which allows users to exchange services and information openly on the Internet used to achieve the desired technical effect and transformation. A user will be enabled to operate as both a consumer and producer of any and all digital content or information through one or more master system servers.

A user executes a browser to view digital content items and can connect to the front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website at any time. The user may include a variety of different computing devices. Examples of user devices include, but are not limited to, personal computers, digital assistants, personal digital assistants, cellular phones, mobile phones, smart phones or laptop computers.

The browser can include any application that allows users to access web pages on the World Wide Web. Suitable applications include, but are not limited to, Microsoft Internet Explorer®, Netscape Navigator®, Mozilla® Firefox, Apple® Safari or any application adapted to allow access to web pages on the World Wide Web. The browser can also include a video player (e.g., Flash™ from Adobe Systems, Inc.), or any other player adapted for the video file formats used in the video hosting website. Alternatively, videos can be accessed by a standalone program separate from the browser. A user can access a video from the website by, for example, browsing a catalog of digital content, conducting searches on keywords, reviewing aggregate lists from other users or the system administrator (e.g., collections of videos forming channels), or viewing digital content associated with particular user groups (e.g., communities).

### V. Computer Network Environment

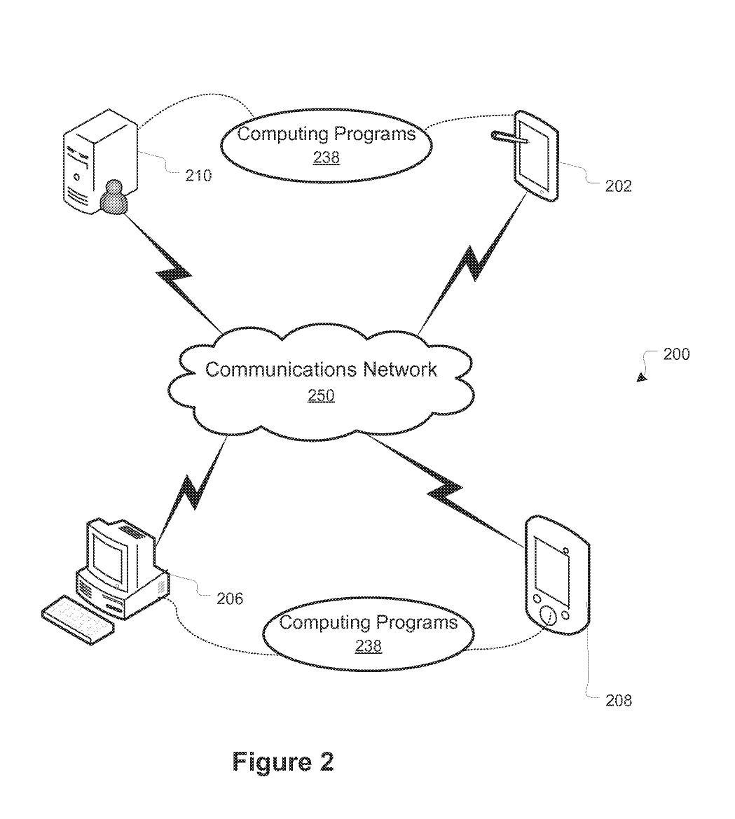

Computing system 100, described above, can be deployed as part of a computer network used to achieve the desired technical effect and transformation. In general, the above description for computing environments applies to both server computers and client computers deployed in a network environment. FIG. 2 illustrates an exemplary illustrative networked computing environment 200, with a server in communication with client computers via a communications network 250. As shown in FIG. 2, server 210 may be interconnected via a communications network 250 (which may be either of, or a combination of a fixed-wire or wireless LAN, WAN, intranet, extranet, peer-to-peer network, virtual private network, the Internet, or other communications network) with a number of client computing environments such as tablet personal computer 202, mobile telephone, smart phone 205, personal computer 206, and personal digital assistant 208. In a network environment in which the communications network 250 is the Internet, for example, server 210 can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Other wireless protocols can be used without departing from the scope of the disclosure, including, for example Wireless Markup Language (WML), DoCoMo i-mode (used, for example, in Japan) and XHTML Basic. Additionally, networked computing environment 200 can utilize various data security protocols such as secured socket layer (SSL) or pretty good privacy (PGP). Each client computing environment can be equipped with operating system 238 operable to support one or more computing applications, such as a web browser (not shown), or other graphical user interface (not shown), or a mobile desktop environment (not shown) to gain access to server computing environment 200.

In operation, a user (not shown) may interact with a computing application running on a client computing environment to obtain desired data and/or computing applications. The data and/or computing applications may be stored on server computing environment 200 and communicated to cooperating users through client computing environments over exemplary communications network 250. The computing applications, described in more detail below, are used to achieve the desired technical effect and transformation set forth. A participating user may request access to specific data and applications housed in whole or in part on server computing environment 200. These data may be communicated between client computing environments and server computing environments for processing and storage. Server computing environment 200 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

### VI. Media Independent Information Service

The Media Independent Information Service (MilS) provides a framework and corresponding mechanisms by which an MIHF entity may discover and obtain network information existing within a geographical area to facilitate handovers. Additionally or alternatively, neighboring network information discovered and obtained by this framework and mechanisms can also be used in conjunction with user and network operator policies for optimum initial network selection and access (attachment), or network re-selection in idle mode.

MIIS primarily provides a set of information elements (IEs), the information structure and its representation, and a query/response type of mechanism for information transfer. The information can be present in some information server from which, e.g., an MIHF in the Mobile Node (MN) can access it.

Depending on the type of mobility, support for different types of information elements may be necessary for performing handovers. MilS provides the capability for obtaining information about lower layers such as neighbor maps and other link layer parameters, as well as information about available higher layer services such as Internet connectivity.

MIIS provides a generic mechanism to allow a service provider and a mobile user to exchange information on different handover candidate access networks. The handover candidate information can include different access technologies such as IEEE 802 networks, 3GPP networks and 3GPP2 networks. The MilS also allows this collective information to be accessed from any single network. For example, by using an IEEE 802.11 access network, it can be possible to get information not only about all other IEEE 802 based networks in a particular region but also about 3GPP and 3GPP2 networks. Similarly, using, e.g., a 3GPP2 interface, it can be possible to get access to information about all IEEE 802 and 3GPP networks in a given region. This capability allows the MN to use its currently active access network and inquire about other available access networks in a geographical region. Thus, a MN is freed from the burden of powering up each of its individual radios and establishing network connectivity for the purpose of retrieving heterogeneous network information. MilS enables this functionality across all available access networks by providing a uniform way to retrieve heterogeneous network information in any geographical area.

### VII. Software Programs Implementable in the Computing and Network Environments to Achieve a Desired Technical Effect or Transformation

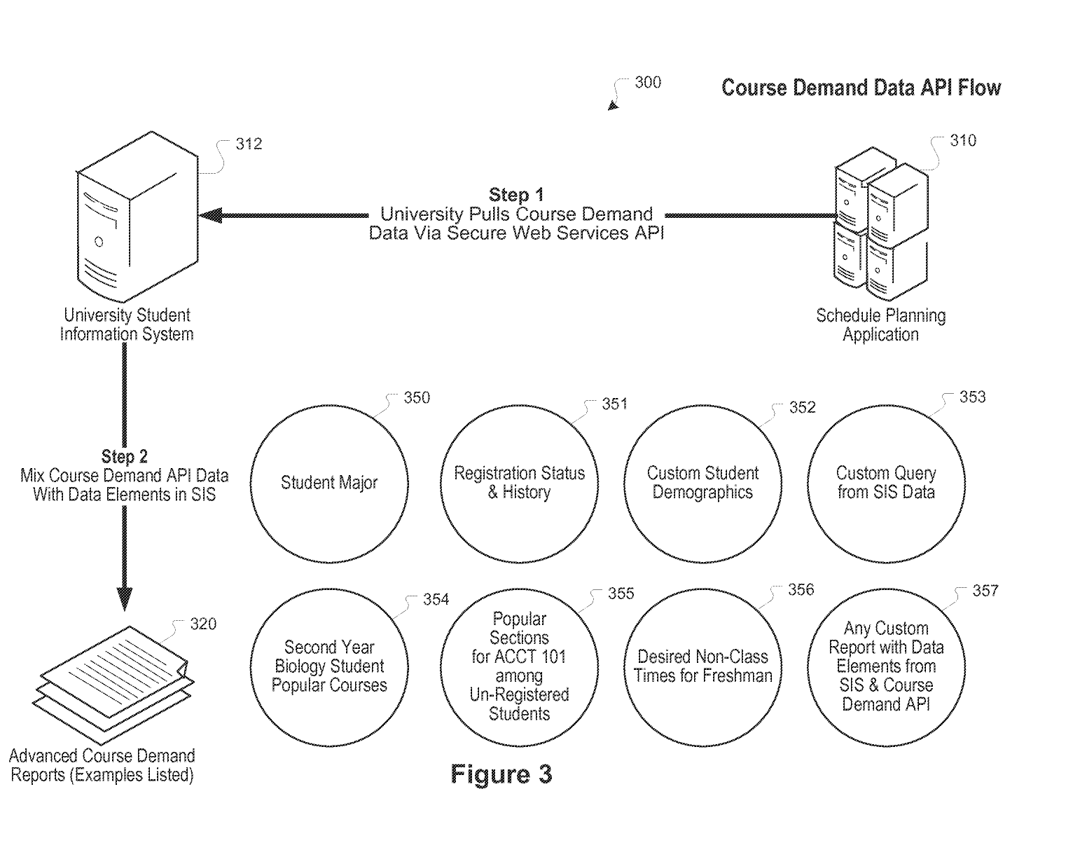

FIG. 3 illustrates a course registration course demand data API flow 300. The system has a server hosting a schedule planning application 310 which is in communication with a student information system 312. The data flow enables generation of course demand reports 320. In one configuration, the system is accessible by university administrators and enables the administrators to view real time, or near real time, course demand reports. The reports show information about which courses students are planning for when developing their (the students) schedule. In one configuration, aggregate demand reports are available which show the number of students planning each course, which can be grouped by the subject and or the course number. A variety of information is available including, but not limited to: student major 350, registration status and/or history 351, student demographics 352, custom query from SIS data 353, second year biology student popular courses 354, popular sections for ACCT 101 among unregistered students 355, desired non-class times for freshmen 356, custom report with data elements from SIS and Course Demand APPI 357.

As will be appreciated, aggregate demand reports are generatable and available which show the number of students planning each course, grouped by the subject and course number.

Course demand can also be broken down to the student level, which enables an institution to see particular student IDs which uniquely identify a student and the list of courses that particular student is planning for.

Students can also mark particular sections as preferred sections in the schedule planning software as well as exclude sections they dislike. This section demand information is accessible grouped by the section as well as down to the student level.

Break information is aggregated into a report so institutions can view the various days and times that students are scheduling around. This break information can be used to appropriately plan classes around the times that most students are trying to avoid taking class.

All course demand data is accessible via API for real-time data analysis by all student and registration data in Student Information System.

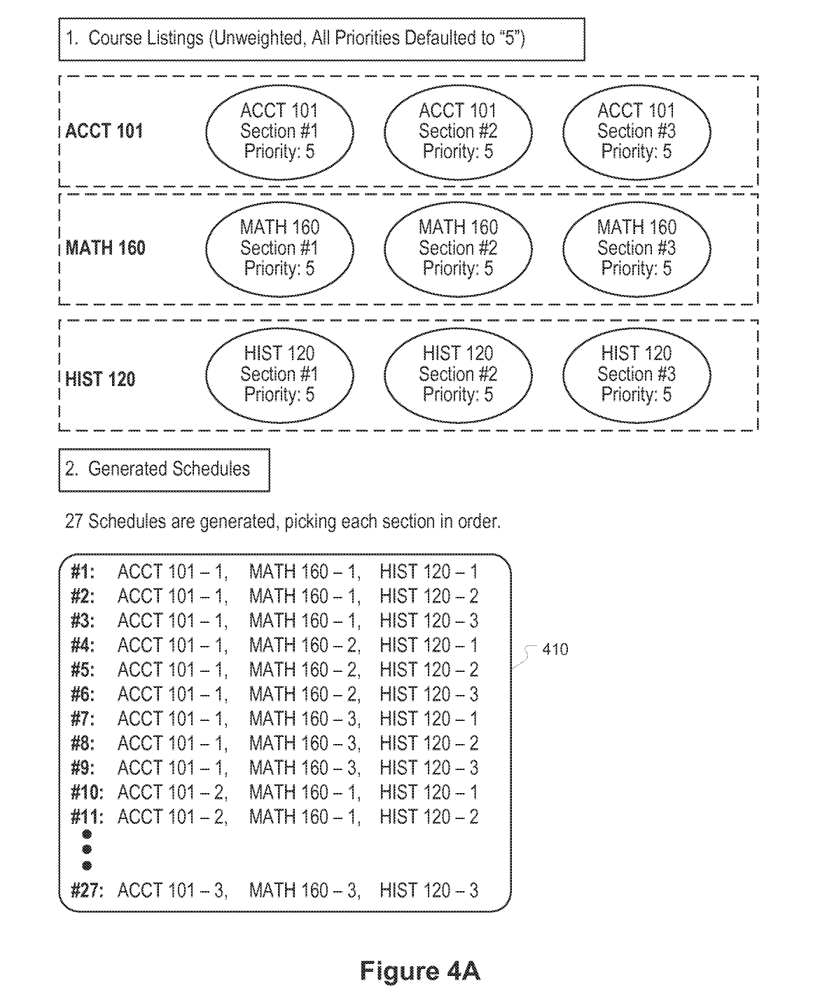

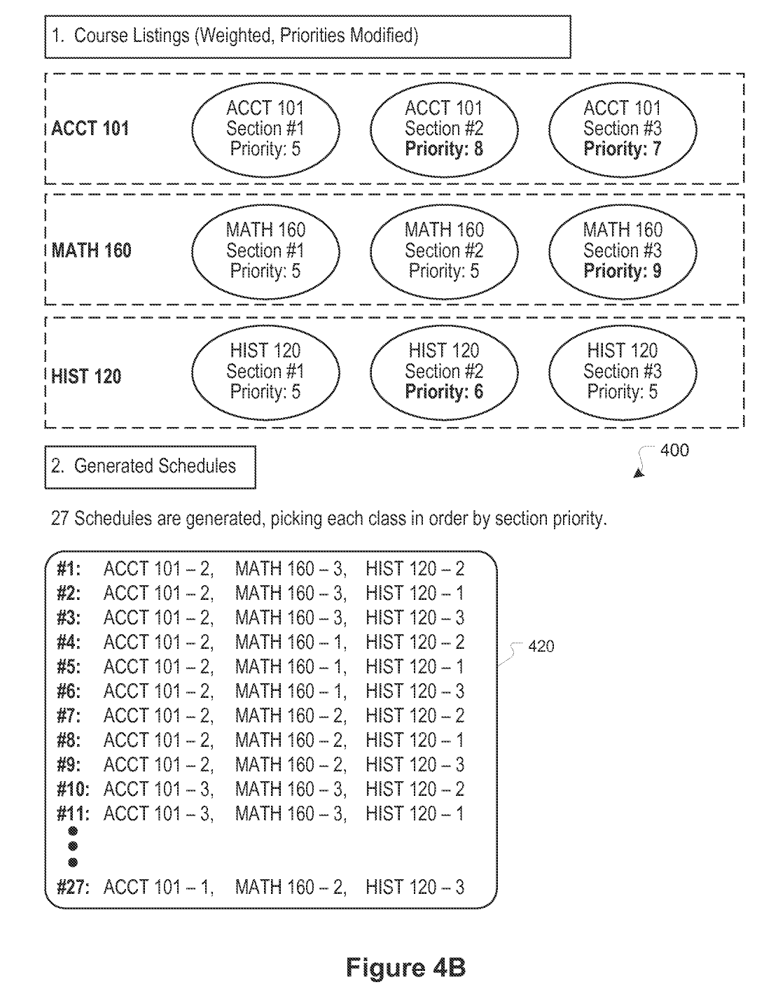

FIGS. 4A-B illustrate a course optimization engine, both weighted and unweighted. As shown in FIG. 4A, unweighted course listings are shown, with all priorities defaulted to 5. From the course listings, a schedule is generated 410. Because the courses are unweighted, for a student wishing to take Accounting 101, Math 160 and History 120, the system generates the classes in order.

In FIG. 4B, the courses are weighted and their priorities are modified. From this list schedules are generated where classes are picked in order by section priority. Because the courses are weighted, for a student wishing to take the same classes, Accounting 101, Math 160 and History 120, the system generates the classes in a preferential order by highest priority first.

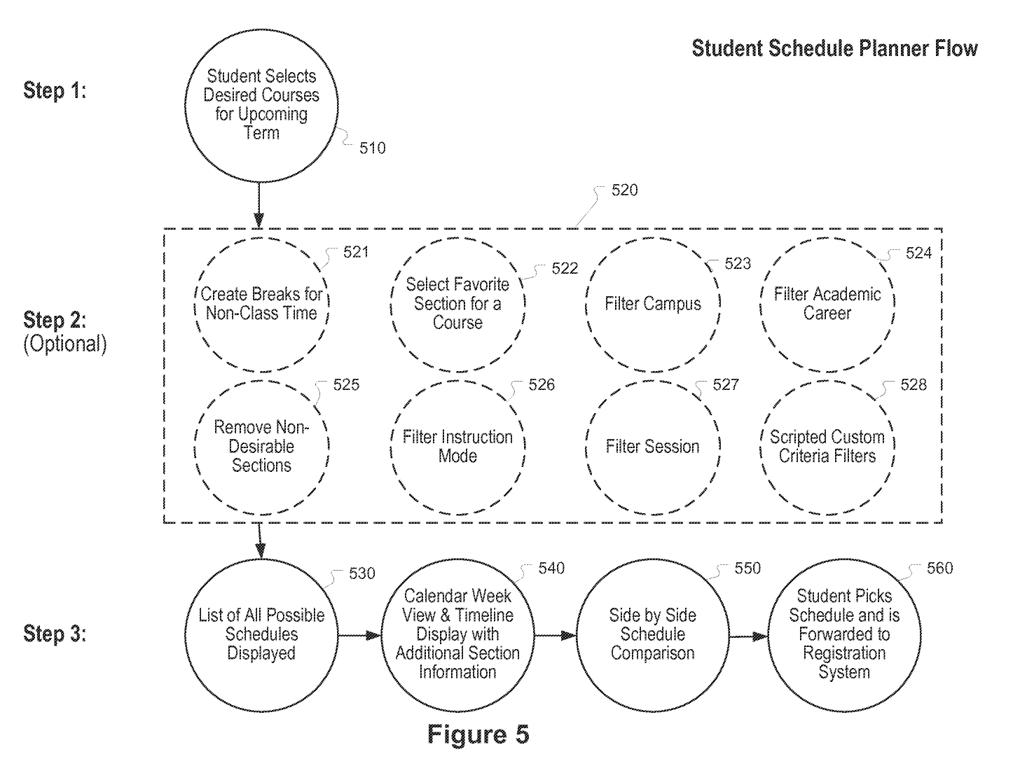

FIG. 5 illustrates a student schedule planner 500. Students select desired courses for upcoming terms 510. During an optional step 520, students can, for example, create breaks for non-class time 521, select a favorite section for a course 522, filter courses by campus 523, filter courses by academic career 524, remove non-desirable sections 525, filter instruction mode (e.g., lecture vs. seminar) 526 or class size, filter session 527, or apply other custom scripted filters 528. Thereafter, a list of possible schedules is generated and displayable 530. The order of the schedules can be listed in an order that takes into account the student's desires, but also factors in the administrations priority (e.g., wishing to fill a particular section first). From there, a calendar week view and timeline can be displayed with additional section information 540. Additionally, a side by side schedule comparison can be generated and viewed 550. At the end of the process, the student picks a schedule which is then forwarded to the registration system 560.

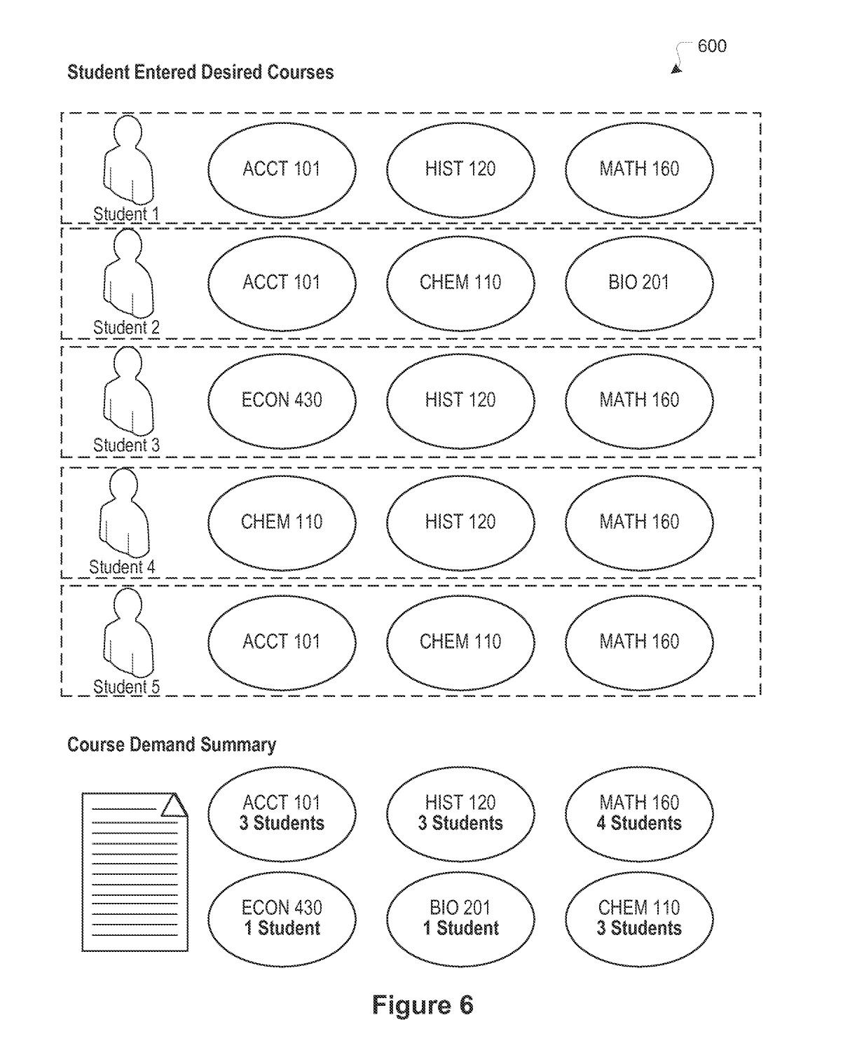

FIG. 6 illustrates course demand 600 which is capable of generating a course demand summary. This enables administrators to identify courses which may warrant higher priority to facilitate student enrollment.

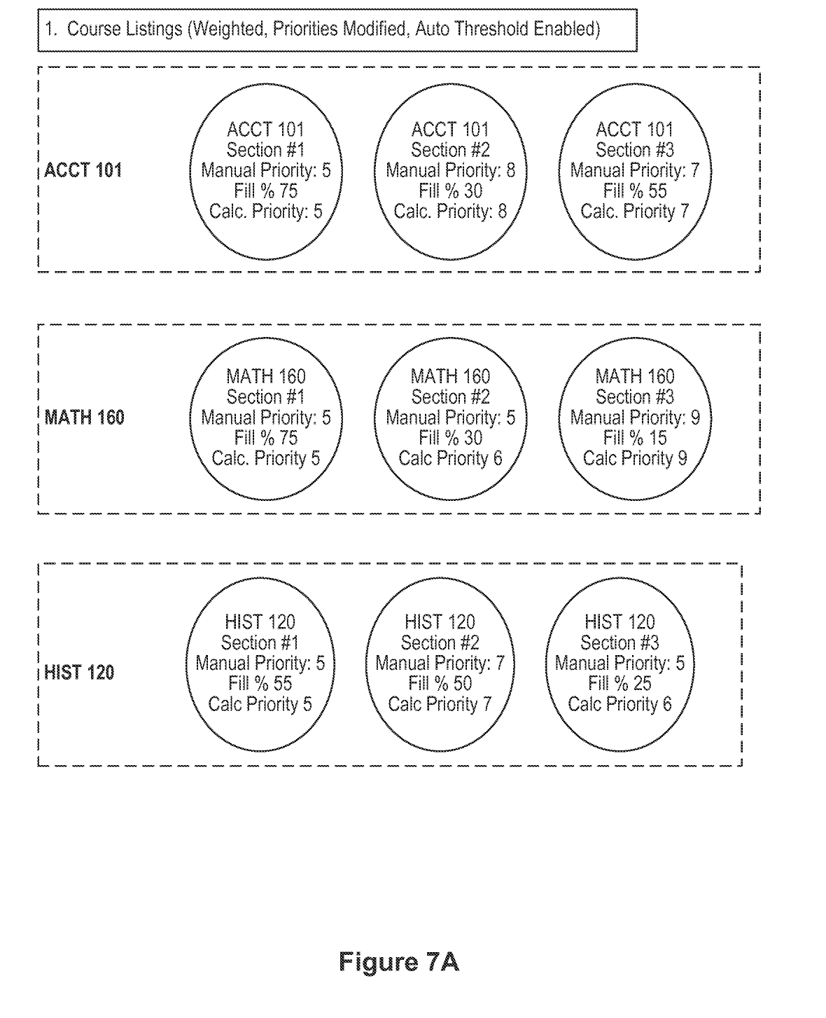

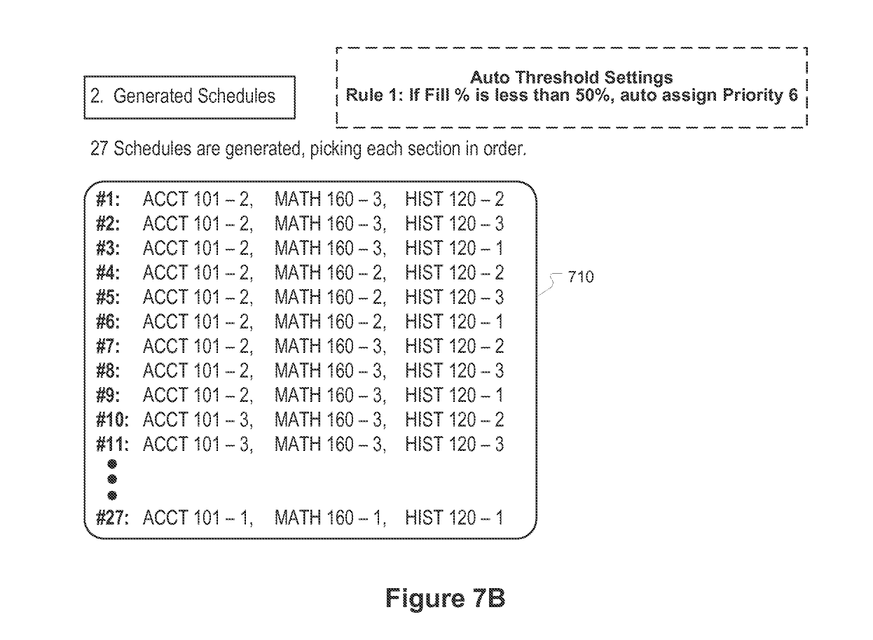

FIGS. 7A-B illustrate a course optimization engine, weighted with priorities modified and auto threshold enabled. As shown in FIG. 7A, weighted course listings are shown. The coursesw have both manual priorities set, e.g., by an administrator, and a calculated priority. When using this system, an administrator can set an auto threshold rule which allows priorities to be automatically assigned, for example, to sections based on parameters, such as Fill %. Thus, for example, an auto threshold rule could be to assign priority 6 to any section that has less than a 50% fill. Any manually set priorities can be configured to override the auto threshold calculation.

Thus, for example, an exemplar rule could be:
Step 1: For each threshold rule, evaluate all sections and if the rule matches the section, assign a corresponding priority value
Step 2: For each section, assign the priority set by the administrator. Any priority assigned in step 1 can be overwritten by the priority set by the Administrator in Step 2.

Once the priorities are determined, e.g., based on fill percent, schedules are generated wherein each class is picked by calculating section priority.

### VII. Methods of Implementing the Processes

Student Schedule Planner as shown and discussed above with respect to FIG. 5 is an area where students plan their schedules. It involves a database of the institution's scheduling data that is constantly updated and allows students to pick from available classes to develop their schedule. The basic flow for a student is for the student to select desired courses, optionally tailor the schedule, obtain a list of possible schedules meeting the student's criteria, view the schedules, and then select a schedule which is then forwarded to the registrar.

Thus, for example, a student enters into the schedule planner the courses they wish to take. The student can optionally pick courses from a degree planner software that the institution is already using, separate from the student schedule planner. Student can also enter times in which they are trying to avoid taking class, such as for personal times such as jobs or athletic practices. The student is able to filter schedules by various parameters such as campus, parts of the upcoming term (such as summer sessions that only span half of the semester), instruction mode, academic career, academic groups, and course status (such as open classes or open and full classes) The course list is dynamically filtered by all of these parameters and will take into account advanced co-requisite setups such as particular sections of one course being associated with linked labs and lectures or cross course co-requisites.

Available schedules are presented to the student and all schedule detail is available to the student by clicking on the schedule. Course notes and other information associated with that schedule is displayed to the student. In some configurations, students are able to compare multiple schedules side by side and hover the mouse over a schedule to view a preview of the schedule.

Students with accessibility needs are provided with a text only version of the software which allows all functionality as in the regular version. Blind students using screen readers have full use of the software and can operate the software without the use of a mouse.

Enrollment Optimization Engine-This component is accessed by university administrators. It allows the administrators to view reports of one or more courses and assign a 1-10 priority value to each section that is being offered.

Administrators open up the Enrollment Optimization Engine and select courses by term, subject and course number. There is no limit to the amount of courses that can be viewed in one report.

Sections are presented by the Fill % which is calculatable by the number of filled seats divided by the number of total seats in the section. The Fill % can also be color coordinated based on pre-defined rules that identify if the section has a low fill, medium fill, and high fill percentage if desired. A low fill can, for example, correspond to 50% fill or lower, a medium fill can correspond to 51% to 75% fill, and the high fill is 76% or higher. Low is colored red, medium yellow, and high fill is green. This is to draw attention to the red sections which would be advantageous to the institution to raise the priority on those red sections.

Reports of various courses can be saved by administrators for easy access in a future session using the software. Reports can also be shared with other administrators.

There is a permissions system for the module in which particular administrators are allowed access broken down by subject and campus. There is a module for super users which allow the permissions to be the module to be granted and to control the secondary permissions for subject and campus.

All generated schedules for students will contain sections with the highest priority weights in the top search results. Schedules are ordered by administrator entered priority value of 1-10 for each section. (“Enrollment Optimization Engine Schedule Priority.pdf”)

Features that are likely to influence a potential customer to purchase a product manufactured under a patent filed from this disclosure.

Weighting of particular sections in order to balance enrollment across available course offerings.

Viewing of aggregate course demand from the actual schedule planning process that takes place immediately prior to and during the registration period.

Automatic Reporting of schedule permutations for customizable schedule generation scenarios.

Consider how a competitor might attempt to incorporate this innovation into their own product and/or design around this innovation.

A competitor would aim to open up an interface for the administrator to weight individual sections and attempt to provide those course offerings to the student in an ordered fashion. If a competitor had an automated schedule planner for use by students, they would order the schedule planning results by the weighting of the sections.

A competitor would also provide a reporting engine to automatically generate possible schedule permutations.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A tangible machine readable medium storing instructions that, when executed by a computing device, cause the computing device to perform a method of compiling a course schedule, comprising:
creating a single record for each individual course;
obtaining a selection of one or more courses from a user;
generating a list of two or more course schedules without user interaction; and
presenting the list of two or more course schedule to the user.

2. The tangible machine readable medium of claim 1 wherein the performed method further comprises, identifying one or more of each of available times for class, unavailable times for class, academic career, and course of study.

3. The tangible machine readable medium of claim 1 wherein the performed method further comprises, identifying for each course one or more of a favorite section, an undesirable section, and an instruction mode.

4. The tangible machine readable medium of claim 1 wherein the course record is equally weighted with all other course records.

5. The tangible machine readable medium of claim 1 wherein the course record is weighted.

6. The tangible machine readable medium of claim 1 wherein courses are displayed at available times in order of weight.

7. The tangible machine readable medium of claim 1 wherein two or more course schedules are viewable side by side.

8. The tangible machine readable medium of claim 1 further comprising the step of selecting a course schedule.

9. The tangible machine readable medium of claim 1 further comprising the step of forwarding he selected course schedule to a central registration system.

10. The tangible machine readable medium of claim 1 wherein the courses are weighted according to one or more of fill percentage, calculated priority, and manual priority.

11. A method of enrolling in a course comprising:
creating a single record for each individual course in a centrally accessible system;
obtaining a selection of one or more courses from a user;
generating a list of two or more course schedules without user interaction; and
presenting the list of two or more course schedule to the user.

12. The method of claim 11 wherein the performed method further comprises, identifying one or more of each of available times for class, unavailable times for class, academic career, and course of study.

13. The method of claim 11 wherein the performed method further comprises, identifying for each course one or more of a favorite section, an undesirable section, and an instruction mode.

14. The method of claim 11 wherein the course record is equally weighted with all other course records.

15. The method of claim 11 wherein the course record is weighted.

16. The method of claim 15 wherein courses are displayed at available times in order of weight.

17. The method of claim 11 wherein two or more course schedules are viewable side by side.

18. The method of claim 11 further comprising the step of selecting a course schedule.

19. The method of claim 18 further comprising the step of forwarding the selected course schedule to a central registration system.

20. The method of claim 11 further comprising the step of weighting the courses according to one or more of fill percentage, calculated priority, and manual priority.
